(19) United States
(12) Patent Application Publication
(10) Pub. No.: US 2012/0266560 A1
(43) Pub. Date: Oct. 25, 2012

(54) Self-counterboring, screw-threaded headed fastener with enlarged flanged portion or wings having cutting teeth thereon, and cutting wrench/screw gun sockets

(75) Inventors: Cheryl L. Panasik, Elburn, IL (US); Yongping Gong, Wilmette, IL (US); Louis Thomas, Maywood, IL (US); Kevin Tucker, Chicago, IL (US); Horea Ilea, Wood Dale, IL (US); Anthony A. Czarkowski, Downers Grove, IL (US)

(73) Assignee: ILLINOIS TOOL WORKS INC.

(21) Appl. No.: 13/064,857

(22) Filed: Apr. 21, 2011

(51) Int. Cl. F16B 25/10; B25B 13/06; F16B 23/00; E04C 2/00

(52) U.S. Cl. 52/783.1; 411/387.4; 81/121.1

(57) ABSTRACT

A self-counterboring screw-threaded headed fastener, for the threaded insertion into an underlying fixed support or substrate in order to fixedly secure a structural component, such as, for example, an insulated metal panel (IMP), to the underlying fixed support or substrate without the need for pre-drilling a bore within the insulated metal panel (IMP), in order to accommodate the screw-threaded head of the fastener, prior to the insertion of the screw-threaded fastener into and through the insulated metal panel (IMP) for fixation within and to the underlying fixed support or substrate, is disclosed. Cutting wrench or screw-gun sockets are also disclosed for similar purposes.

### FIELD OF THE INVENTION

This patent application relates generally to screw-threaded fasteners, and more particularly to a new and improved self-counterboring, screw-threaded headed fastener for the threaded insertion into an underlying fixed support or substrate in order to fixedly secure a structural or non-structural component, such as, for example, an insulated metal panel (IMP), to the underlying fixed support or substrate without the need for pre-drilling a bore within the insulated metal panel (IMP), in order to accommodate the screw-threaded fastener head, prior to the insertion of the screw-threaded fastener into and through the insulated metal panel (IMP) for fixation within and to the underlying fixed support or substrate. A screw-threaded fastener with wing members having cutting teeth, as well as cutting wrench or screw-gun sockets are also disclosed for similar purposes.

### BACKGROUND OF THE INVENTION

Various different types of fasteners or anchors are of course well-known in the art and are utilized for use in connection with different substrates so as to achieve different objectives. Some exemplary types of self-drilling and/or self-tapping fasteners or anchors are disclosed, for example, within U.S. Pat. No. 6,340,277 which issued to Koenig et al. on Jan. 22, 2002, U.S. Pat. No. 6,250,866 which issued to Devine on Jun. 26, 2001, U.S. Pat. No. 6,086,302 which issued to Gerhard on Jul. 11, 2000, U.S. Pat. No. 5,885,041 which issued to Giannuzzi et al. on Mar. 23, 1999, U.S. Pat. No. 5,294,227 which issued to Forster et al. on Mar. 15, 1994, U.S. Pat. No. 5,282,708 which issued to Giannuzzi on Feb. 1, 1994, and U.S. Pat. No. 4,900,207 which issued to McGovern on Feb. 13, 1990.

While the aforenoted exemplary self-drilling and/or self-tapping fasteners or anchors are generally satisfactory, it is to be noted and appreciated that when such fasteners are being employed in their particular environments for their particular purposes, they are usually inserted into bores which have been pre-drilled into, for example, concrete or similar substrates in order to accommodate the fasteners or anchors. Subsequent to the pre-drilling of the aforenoted bores within the substrates for accommodating the self-drilling and/or self-tapping fasteners or anchors, the bores must then be cleaned so as to effectively remove all of the debris from the bores which have been defined within the substrates, as a result of the pre-drilling of the bores within the substrates, prior to the insertion of the self-drilling and/or self-tapping fasteners or anchors within the pre-drilled bores of the substrates. These pre-drilling and cleaning procedures obviously define multi-step procedures which are tedious to perform, and necessarily mandate costly procedural time, however, they must nevertheless be performed before the self-drilling and/or self-tapping fasteners or anchors can in fact be inserted into the bores for threadedly engaging the side-wall portions of the substrate bores, or the substrates themselves, in order to, in turn, fixedly secure a particular component to the substrate. In addition, in other cases, when it is desired to fixedly secure a structural component or non-structural to an underlying fixed support or substrate, when the pre-drilled hole or bore is in fact formed within the structural or non-structural component, the diametrical extent of the bore is necessarily required to be larger than the diametrical extent of the fastener head so as to in fact permit the fastener, including the fastener head, to be inserted into the structural or non-structural component. However, if the pre-drilled bore is then effectively larger in the diametrical extent of the fastener head, the fastener would not in fact be capable of fixedly securing or attaching the structural or non-structural component to the underlying fixed support or substrate.

A need therefore exists in the art for a self-counterboring, screw-threaded headed fastener which effectively permits the insertion of the fastener, including the head portion thereof, into and through a structural or non-structural component, which is to be fixedly secured to an underlying fixed support or substrate, without the need for first pre-drilling a bore within the structural or non-structural component, and wherein, in addition, the structure comprising the headed fastener can additionally ensure the fact that the structural or non-structural component will be fixedly secured to the underlying fixed support or substrate.

### SUMMARY OF THE INVENTION

The foregoing and other objectives are achieved in accordance with the teachings and principles of the various embodiments consistent with the present invention through the provision of a new and improved self-counterboring screw-threaded headed fastener which is provided with an enlarged circular flanged portion disposed adjacent to the head portion of the fastener. The enlarged circular flanged portion has a circumferentially arranged set of cutting teeth integrally formed upon the outer peripheral edge portion thereof for effectively cutting or boring into and through a structural or non-structural component to be affixed to an underlying fixed support or substrate whereupon the structural or non-structural component can be fixedly secured to the underlying support or substrate as a result of the screw-threaded fastener drilling and tapping its way into the underlying fixed support or substrate. In this manner, the structural or non-structural component can in fact be fixedly secured to the underlying support or substrate without requiring a bore to first be drilled within the structural or non-structural component.

In accordance with a first embodiment concerning the usage of the new and improved self-counterboring, screw-threaded headed fastener for affixing a structural or nonstructural component to an underlying support or substrate, the structural or non-structural component may comprise an insulated metal panel (IMP) which is to be affixed to an underlying metal stud, beam, or the like, as may be found in roofing structures, wall structures, floors, or other assemblies. The insulated metal panel (IMP) comprises a laminated sandwich-type structure which includes an upper or top steel sheet, a lower or bottom steel sheet, and an intermediate core which may be fabricated, for example, from rigid polyurethane or some other rigid material such as, for example, nonchlorofluorocarbon (non-CFC) polyisocyanurate foam. As the enlarged circular flanged portion, having the circumferentially arranged set of cutting teeth disposed thereon, cuts through the upper or top steel sheet, a washer is effectively formed from the upper steel sheet and becomes seated beneath the enlarged circular flanged portion.

Due to the heat and pressure generated during the cutting of the upper or top steel sheet, the washer is effectively deformed so as to comprise a substantially hemispherical or domed-shaped donut which is effectively fixedly disposed internally within and beneath the enlarged circular flanged portion by means of an interference fit or the like.

The axial depth of the cutting teeth is therefore effectively decreased by the axial thickness of the hemispherical or domed-shaped steel washer. Accordingly, together with the termination of the screw threads upon the threaded shank portion of the fastener within the vicinity of the enlarged circular flanged portion, the penetration of the fastener completely through the lower-most portion of the foam core of the insulated metal panel (IMP) and into the lower steel sheet portion of the insulated metal panel (IMP) is effectively prevented. However, the tip portion of the fastener, and the lower or distal end portion of the threaded shank portion of the fastener, do in fact penetrate through the lower steel sheet portion of the insulated metal panel (IMP) and effectively tap into the underlying support or substrate such that the laminated component is able to be fixedly secured to the underlying fixed support or substrate. As a specific example, the tip portion of the headed fastener may comprise a self-drilling tip. In addition, the threaded shank portion of the headed fastener of the present invention may comprise self-tapping threads.

While the new and improved fastener consistent with the teachings and principles of the present invention may be utilized in conjunction with the aforenoted panel assembly whereby, for example, an insulated metal panel (IMP) may be affixed to an underlying stud, beam, or other substrate, the new and improved fastener may also be utilized in conjunction with other or different structural or non-structural assemblies. For example, the fastener may be inserted into a concrete or wooden substrate. For this system, the fastener needs to be modified to the effect that in addition to the cutting teeth being provided upon the outer peripheral edge portion of the enlarged circular flanged portion, additional cutting teeth are also provided upon the internal undersurface portion of the enlarged circular flanged portion in order for the entire enlarged circular flanged portion to effectively grind away and/or pulverize the upper regions of the concrete or wooden substrate as the fastener is inserted downwardly into the concrete or wooden substrate. Still further, in accordance with this modified or second embodiment consistent with the teachings and principles of the present invention fastener, the head portion of the fastener is provided with an internally threaded bore for receiving, for example, a screw fastener or stud by means of which an auxiliary fixture or structure can effectively be secured to the present invention fastener which is of course, in turn, fixedly secured to and within the underlying concrete or wooden substrate. The fastener may also be modified to have a gimlet point in place of the self-drilling point for use in wood or concrete.

Alternatively, and still further, in lieu of the aforenoted fixation of the insulated metal panel (IMP) to the underlying support or substrate, a different structure, such as, for example a first wooden structural or non-structural member may be fixedly secured to a second underlying wooden structural or member or substrate, or still yet further, a wooden structural or non-structural member may be fixedly secured to an underlying steel, other metal, or concrete substrate. Still yet further, in lieu of the new and improved self-counterboring screw-threaded headed fastener, comprising the head portion, the threaded shank portion, and the enlarged circular flanged portion being fabricated as a one-piece fastener, as has been previously described, the enlarged circular flanged portion may be fabricated separately from the primary structure of the fastener, comprising the head portion and the shank portion of the fastener, and may be fixedly secured onto the shank portion of the fastener by any one of a multitude of securing techniques so as to again be disposed adjacent to the head portion of the fastener. Accordingly, the resulting composite structure is effectively the same as that of the original embodiment whereby the enlarged circular flanged portion, having the cutting teeth thereon, can operate to effectively form the washer component from the upper or top steel sheet member of, for example, an insulated metal panel (IMP). Yet still further, in lieu of the provision of the enlarged circular flanged portion upon the headed fastener, diametrically opposed wing members, having cutting teeth disposed thereon, can likewise be utilized to provide the self-countering effect for forming the bore within which the head of the headed fastener can be accommodated during insertion of the headed fastener into and through, for example, the insulated metal panel (IMP).

As will also become apparent hereinafter, cutting wrench or screw gun sockets may also be employed in connection with conventional self-drilling, self-tapping screw-threaded fasteners for achieving the various objectives consistent with the teachings and principles of the present invention in manner similar to those achieved by means of the fasteners having the enlarged circular flanged portion thereon.

### BRIEF DESCRIPTION OF THE DRAWINGS

Various other features and attendant advantages of the embodiments consistent with the present invention will be more fully appreciated from the following detailed description when considered in connection with the accompanying drawings in which like reference characters designate like or corresponding parts throughout the several views, and wherein:

FIG. 1 is a side elevational view of a first embodiment of a new and improved self-counterboring screw-threaded headed fastener as constructed in accordance with the principles and teachings consistent with the present invention and showing the primary structural components thereof;

FIG. 2 is a perspective view of the first embodiment of the new and improved self-counterboring screw-threaded headed fastener as shown in FIG. 1 and likewise showing the primary structural components thereof;

FIG. 3 is a schematic cross-sectional view illustrating the use of the fastener, as disclosed within FIGS. 1 and 2, for securing a laminated sandwiched structural component, which may be, for example, an insulated metal panel (IMP), to an underlying substrate which may comprise, for example, a wall or ceiling/roofing stud or joist;

FIG. 4 is a schematic cross-sectional view, similar to that of FIG. 3, illustrating, however, the use of the fastener, as disclosed within FIGS. 1 and 2, for securing a laminated sandwiched component, which may be, for example, an insulated metal panel (IMP) having a roofing deck member incorporated within the lower surface portion thereof, to an underlying substrate which may comprise, for example, a roofing stud or joist;

FIG. 5 is a front elevational view of a washer formed from the upper steel sheet of an insulated metal panel (IMP), as shown in FIG. 3, by means of the fastener illustrated within FIGS. 1 and 2;

FIG. 6 is a side elevational view, similar to that of FIG. 1, showing, however, the disposition of the washer upon the threaded shank portion of the fastener after the washer has been formed from the upper steel sheet of an insulated metal panel (IMP), as shown in FIG. 3, by means of the fastener illustrated within FIGS. 1 and 2;

FIG. 7 is a perspective view of an insulated metal panel (IMP) fixedly secured to an underlying support structure, with part of the central or intermediate core portion of the insulated metal panel (IMP) having been removed so as to effectively illustrate precisely how the fastener has penetrated the insulated metal panel (IMP) but has not penetrated the lower steel sheet of the insulated metal panel (IMP) such that the fastener can in fact fixedly secure the insulated metal panel (IMP) to the underlying underlying support structure;

FIG. 8 is a side elevational view of a second embodiment of a new and improved self-counterboring screw-threaded headed fastener, as constructed in accordance with the principles and teachings consistent with the present invention and showing the primary structural components thereof, which is similar to the first embodiment of the fastener as disclosed within FIGS. 1 and 2, however, the same has been structurally modified so as to enable this second embodiment fastener to be employed within a wooden or concrete substrate;

FIG. 9 is a perspective view of the second embodiment of the new and improved self-counterboring, screw-threaded headed fastener as shown in FIG. 8 and likewise showing the primary structural components thereof;

FIG. 10 is a schematic elevational view of a second embodiment of an enlarged circular flanged portion of the self-counterboring screw-threaded headed fastener when the enlarged circular flanged portion of the self-counterboring screw-threaded headed fastener is fabricated as a separate component or element from the primary screw fastener per se;

FIG. 11 is a perspective view of a wrench or screw gun socket, constructed in accordance with the teachings and principles consistent with the present invention, which, together with a screw-threaded fastener, can likewise be utilized to achieve the basic objectives of the present invention;

FIG. 12 is a perspective view of a wrench socket substantially similar to the wrench or screw gun socket illustrated within FIG. 11 but modified so as to have a somewhat dissimilar external structure;

FIGS. 13a-d are side-elevational views of a different screws which may be used as a component part of the new and improved self-counterboring screw-threaded headed fastener consistent with the teachings and principles of the present invention; and

FIG. 14 is a side elevational view of a self-counterboring screw-threaded headed fastener having wing members disposed thereon upon diametrically opposite sides of the shank portion of the fastener and wherein the wing members have cutting teeth thereon so as to effectively serve a similar counterboring purpose as that achieved by means of the enlarged circular flanged portion of the fastener disclosed within FIGS. 1 and 2.

### DETAILED DESCRIPTION OF THE PREFERRED EMBODIMENT

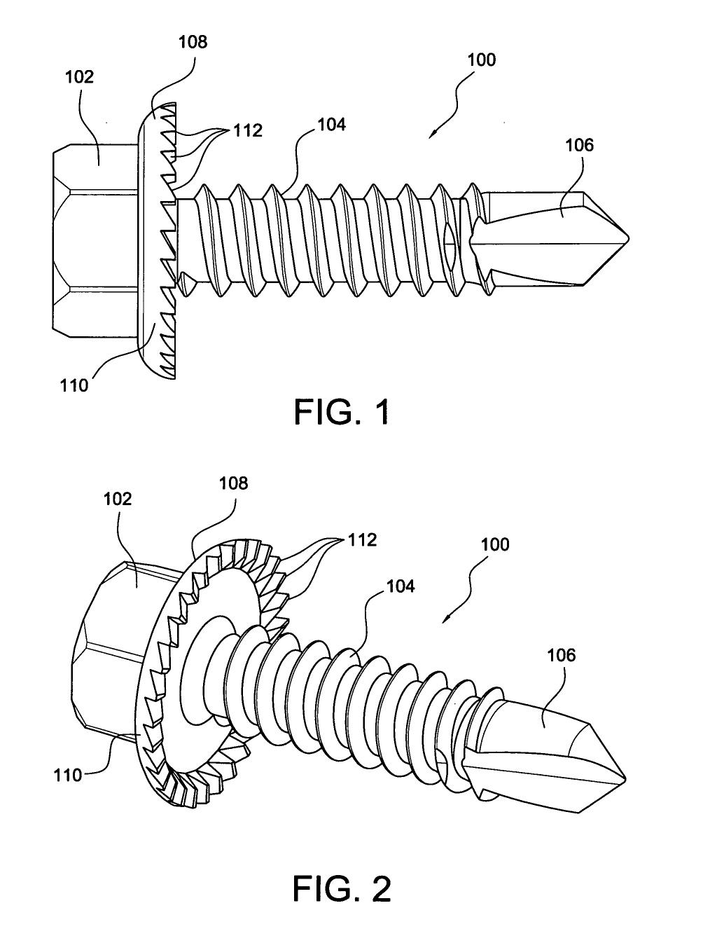

Referring now to the drawings, and more particularly to FIGS. 1 and 2 thereof, a first embodiment of a new and improved self-counterboring screw-threaded headed fastener, as constructed in accordance with the principles and teachings consistent with the present invention and showing the primary structural components thereof, is illustrated and is generally indicated by the reference character 100. More particularly, it is seen that the fastener 100 comprises a head portion 102, a threaded shank portion 104 defined around a longitudinal axis, and a tip portion 106. The threaded shank portion 104 may comprise self-tapping threads, and the tip portion 106 may comprise the self-drilling point or tip 106. The head portion 102 can have, for example, an external hexagonally-shaped cross-sectional configuration so as to enable a suit-able rotary drive component to be drivingly engaged with the head portion 102 of the fastener 100 so as impart rotary torque to the fastener 100 and thereby drive the same into and through a structural or non-structural component and/or an underlying substrate. In addition, and in accordance with the unique structure characteristic of a first embodiment consistent with the present invention fastener, an enlarged circular flanged portion 108 is integrally formed upon, and extends radially outwardly from, the threaded shank portion 104 so as to be disposed immediately beneath or adjacent to the head portion 102. In addition, as can clearly be seen from FIGS. 1 and 2, the outer peripheral edge portion 110 of the enlarged circular flanged portion 108 is provided with a circumferentially arranged set of axially oriented cutting teeth 112 extending continuously around the entire peripheral edge portion 110 of the enlarged circular flanged portion 108 of the fastener 100. The significance of providing the enlarged circular flanged portion 108, with its array of axially extending or axially oriented cutting teeth 112 upon the outer peripheral edge portion 110 of the enlarged circular flanged portion 108 of the fastener 100, will now be disclosed.

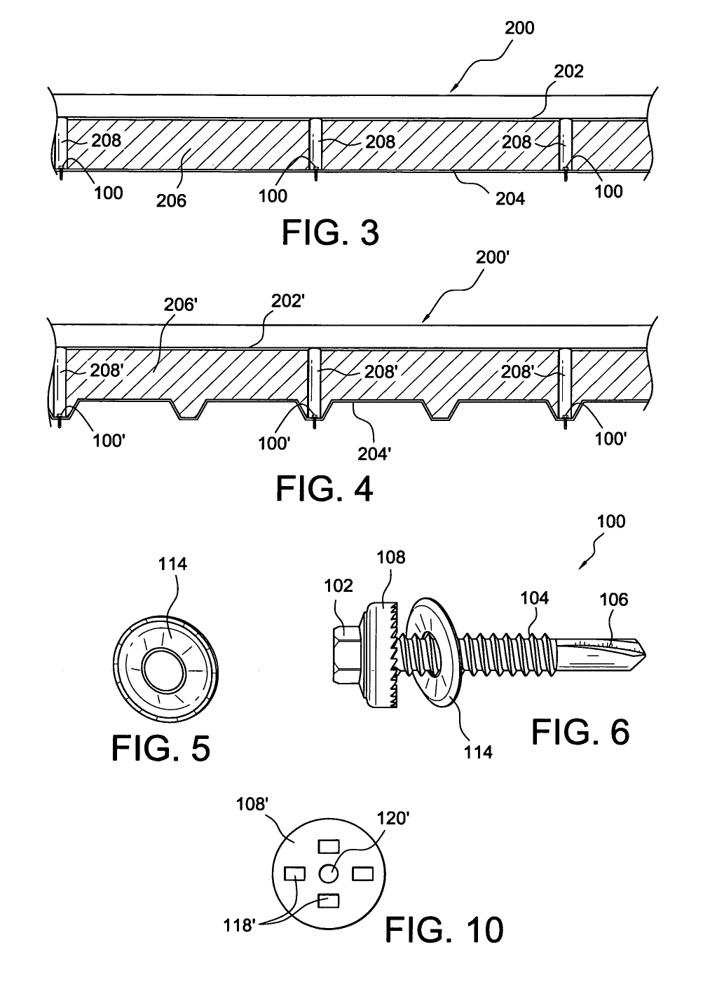

With reference now being made to FIG. 3, one example or environment in connection with which the fastener 100 consistent with the teachings and principles of the present invention is particularly useful is in connection with the fixation of the an insulated metal panel (IMP) structural or non-structural component to an underlying substrate. Insulated metal panels (IMPs) are manufactured, for example, by INSULATED PANEL SYSTEMS of Houston, Tex., and essentially comprise a laminated sandwich-type structure. More particularly, as can readily be appreciated from FIG. 3, a typical insulated metal panel (IMP), generally indicated by the reference character 200, is seen to comprise an upper or top steel sheet 202, a lower or bottom steel sheet 204, and an intermediate core 206 which may be fabricated, for example, from rigid polyurethane or some other rigid material, such as, for example, non-chlorofluorocarbon (non-CFC) polyisocyanurate foam. Conventionally, when an insulated met-al panel (IMP), similar to the insulated metal panel (IMP) 200, was to be affixed to an underlying support structure or substrate, a bore would have to initially be pre-drilled through the insulated metal panel (IMP) so as to permit the shank of a headed fastener to be passed therethrough, the debris from the upper and lower steel sheets, as well as from the intermediate core, would have to be removed from the pre-drilled bore, and then the headed fastener could be inserted into insulated metal panel (IMP). However, it is to be noted that since the drill bit used to pre-drill the bore within the insulated metal panel (IMP) would necessarily have to have an outside diameter (OD) or diametrical extent large enough to permit the head of the fastener to pass there-through, the headed fastener would not in fact be capable of fixedly securing or attaching the insulated metal panel (IMP) to the underlying fixed support or substrate. With the new and improved fastener 100 of the present invention, however, all of these operational drawbacks are effectively eliminated.

More particularly, and with reference again being made to FIGS. 1-3, when the fastener 100 is initially to be inserted into the insulated metal panel (IMP) 200, the fastener 100 is operatively engaged by means of a suitable rotary drive tool, not shown, which operatively engages the hexagonally-configured head portion 102 of the fastener 100.

Accordingly, the tip portion 106, and the threaded shank portion 104, will first penetrate the upper or top steel sheet 202 and will then enter into the intermediate core portion 204 of the panel 200. As the fastener 100 further penetrates the core portion 204 of the panel 200, the cutting teeth 112 of the enlarged flanged portion 108 will engage the upper surface portion of the upper or top steel sheet 202 of the panel 200 whereby the cutting teeth 112 will begin to cut through the upper or top steel sheet 202. When the cutting teeth 112 of the enlarged flanged portion 108 have completely cut through the upper or top steel sheet 202, a washer 114, as illustrated within FIGS. 5 and 6, is formed. In FIG. 5, the washer 114 per se is illustrated as a separate component or element, however, in FIG. 6, the washer 114 is disclosed as being mounted upon the threaded shank portion 104 of the fastener 100, as it would be, after it has been formed by the cutting teeth 112, although for the purposes of FIG. 6, the washer 114 has been manually removed from its naturally-formed disposition within and beneath the enlarged circular flanged portion 108.

More particularly, in connection with the actual formation of the washer 114, in a typical insulated metal panel (IMP), while the thickness of the central or intermediate core portion 206 may vary between, for example, three to six inches (2.00-6.00″), depending upon the particular thermal insulation characteristics or R rating of the panel 200, the upper steel sheet 202 usually has a thickness dimension of 0.015 (0.015″), while the lower steel sheet 204 usually has a thickness dimension of between 0.015-0.048 inches (0.015-0.048″). Therefore, initially, the washer 114, having effectively been formed from the upper steel sheet 202 as a result of the cutting teeth 112 of the enlarged flanged portion of the fastener 100 having cut or severed the washer 114 out from the upper steel sheet 202, will initially have a thickness dimension of 0.015 inches (0.015″) which is the same as that of the upper steel sheet 202. However, due to heat and pressure, generated during the washer-cutting or washer-forming operation, the washer 114 is effectively deformed and is caused to assume a substantially hemispherical or domed-shaped donut-shaped element which has a thickness dimension of, for example, 0.058 inches (0.058″). The washer 114 will also become nested or seated internally within or beneath the enlarged circular flanged portion 108.

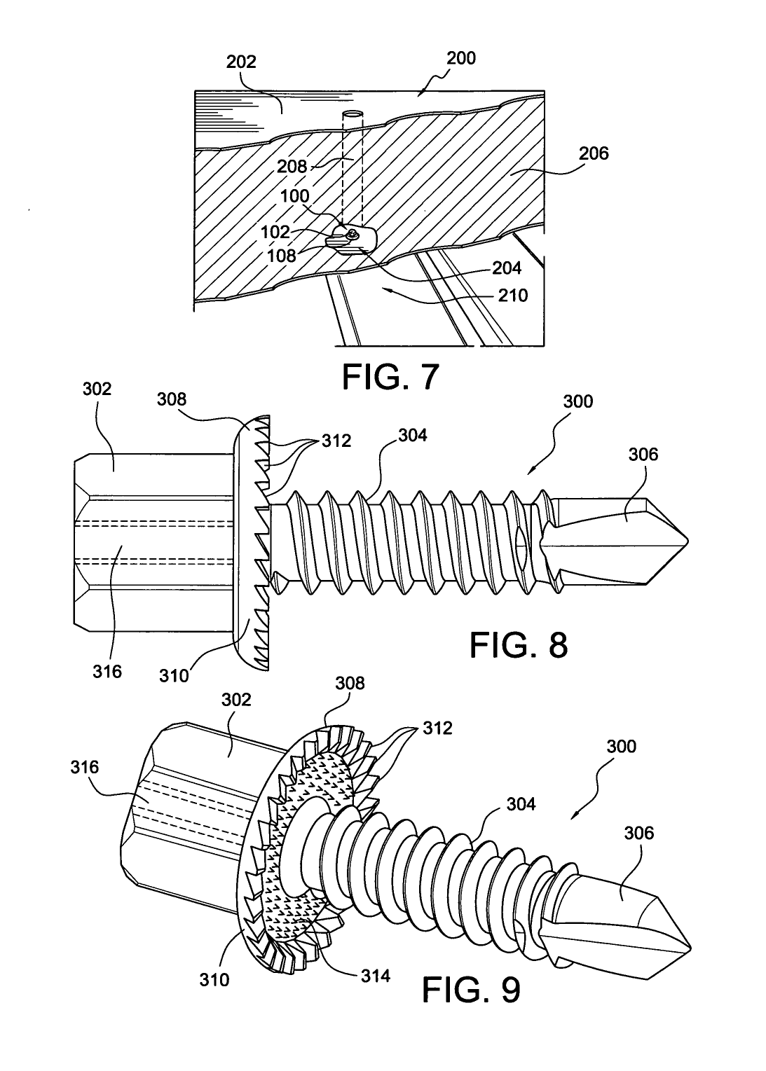

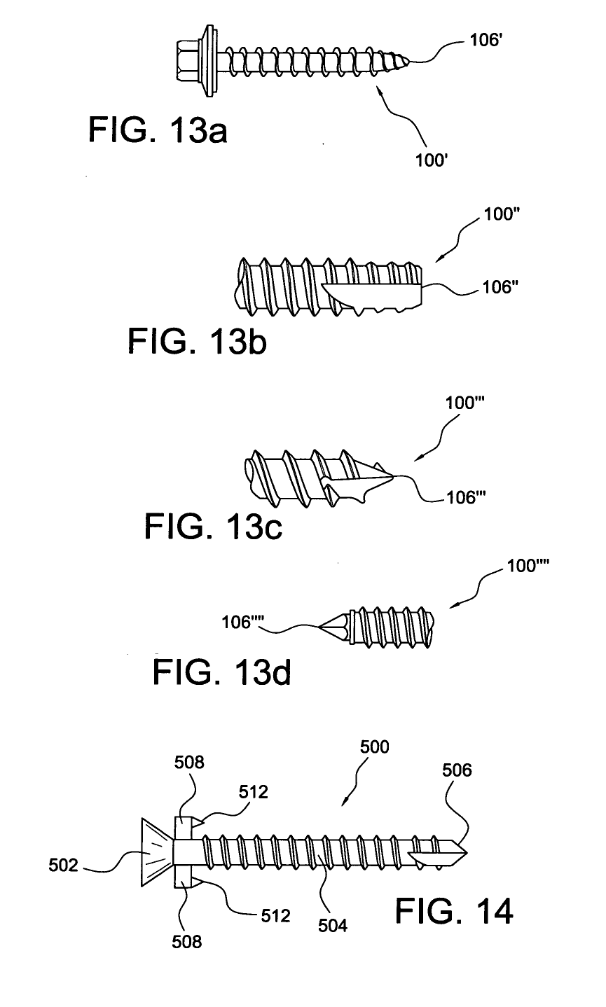

Viewed from another viewpoint, the enlarged circular flanged portion 108 effectively defines a socket within which the washer 114 is housed in a nested or seated state. Accordingly, the depth of the axially extending cutting teeth 112 is specifically made to be, for example, 0.060 inches (0.060″) such that the axially extending cutting teeth 112 will project downwardly or axially toward the pointed tip portion 106 and beyond the axial thickness of the washer 114 by means of, for example, 0.002 inches (0.002″). Therefore, with continued rotation of the fastener 100, the cutting teeth 112 project sufficiently beyond the washer 114 so as to effectively form or define a bore 208 within the core section 206 of the panel 200, however, the termination of the upper end of the thread upon the fastener shank 104, immediately adjacent to the enlarged circular flanged portion 108 and the head portion 102, as well as the aforenoted projection of the cutting teeth 112 beyond the thickness of the washer 114 by only 0.002 inches (0.002″) effectively prevents the cutting teeth 112 from penetrating and cutting the lower steel sheet 204 of the insulated metal panel (IMP) 200. Nevertheless, the tip portion 106 of the fastener 100, as well as the threaded shank portion 104 will in fact penetrate the lower steel sheet 204 of the insulated metal panel (IMP) 200 such that the insulated metal panel (IMP) 200 may in fact be fixedly secured to an underlying support member, steel stud, beam, joist, or the like 210 as can in fact best be seen from FIG. 7. It is to be noted that while the fastener 100 of FIGS. 1 and 2 comprises a self-drilling point 106, sometimes the insulated metal panels (IMPs) already have bores drilled or punched therein. In such a case, in lieu of the self-drilling point 106, other fasteners, having, for example, a gimlet point 106′, a flat point 106″, a sharp point 106″′, or a nail point 106″″ as respectively disclosed upon fasteners 100′,100″, 100′″, and 100″″ as disclosed within FIGS. 13a-13d, can be utilized because one of the critical features of the present invention is the use of the enlarged flanged portion 108, or any equivalent as will be more fully noted hereinafter, along with its cutting teeth 112.

Reverting back to FIG. 4, a modified insulated metal panel (IMP), relative to the insulated metal panel (IMP) 200 as disclosed, for example, within FIG. 3, is disclosed and is generally indicated by the reference character 200′. The modified insulated metal panel (IMP) 200′ is substantially the same as the insulated metal panel (IMP) 200 as disclosed within FIG. 3, and the component parts thereof have accordingly been designated by similar reference characters except that they include an (′). In addition, it is to be noted that in lieu of the planar lower steel sheet 204 of the insulated metal panel 200, the lower steel sheet 204′ of the insulated metal panel 200′ comprises a corrugated member or roof decking integrally incorporated therein. Accordingly, the insulated metal panel (IMP) 200′ can be fixedly secured by means of the fastener 100 of the present invention directly to roof beams, joists, studs, or the like of a building roof, floor, or wall assembly. More particularly, it is noted that the fasteners 100 are disposed within the downwardly projecting portions 210′ of the corrugated lower steel sheet 204′ such that such downwardly projecting portions 210′ of the corrugated lower steel sheet 204′ can be seated upon the roof beams, joists, studs, floors, walls, or the like of the building roof, floor, or wall assembly and fixedly secured thereto by means of the fasteners 100.

Continuing further, and with reference now being made to FIGS. 8 and 9, a second embodiment of a new and improved self-counterboring screw-threaded headed fastener, as constructed in accordance with the principles and teachings consistent with the present invention and showing the primary structural components thereof, is illustrated and is generally indicated by the reference character 300. The second embodiment fastener 300 is similar to the first embodiment fastener 100 as illustrated within FIGS. 1 and 2, except as will be more particularly noted hereinafter, and therefore a detailed description of the same is omitted herefrom in the interest of brevity. More particularly, the primary difference between the second embodiment fastener 300 with respect to the first embodiment fastener 100 resides in the fact that the second embodiment fastener 300 is specifically constructed in order to facilitate the fixation of the same within a wooden or concrete substrate. Accordingly, in addition to the circumferential array of cutting teeth 312 disposed upon the outer peripheral edge surface portion 310 of the enlarged circular flanged portion 308, a multitude of additional auxiliary or secondary grinding or pulverizing teeth 314 are provided upon the entire undersurface portion of the enlarged circular flanged portion 308. In this manner, the second embodiment fastener 300 can be inserted to a predetermined depth into a wooden or concrete substrate as a result of both the cutting teeth 312 and the grinding/pulverizing teeth 314 cutting and grinding/pulverizing the upper portion of the wooden or concrete substrate until the second embodiment fastener 300 has in fact been inserted to its predeterminedly desired depth within the wooden or concrete substrate. With the second embodiment fastener 300 effectively anchored within the wooden or concrete substrate, a separate structural or non-structural component can then effectively be fixedly mounted upon the wooden or concrete substrate through means of the second embodiment fastener 300.

More particularly, in accordance with a still further difference between the second embodiment fastener 300 and the first embodiment fastener 100, the second embodiment fastener 300 is also provided with an internally threaded axially extending bore 316 defined within its head portion 302. In this manner, if a structural or non-structural component is to be affixed to the underlying wooden or concrete substrate, an externally threaded fastener, bolt, or stud can be inserted into the structural or non-structural component, passed through the structural or non-structural component, and threadedly engaged within the internally threaded bore 316 defined within the head portion 302 of the second embodiment fastener 300 thereby affixing the structural or nonstructural component to the underlying wooden or concrete substrate.

One particular practical situation or environment wherein the second embodiment fastener 300 may be so used, is when, for example, shutters or other fixtures are to be fixedly mounted upon wooden or concrete walls of buildings or houses. Still other applications for the usage of the fastener 300 can likewise be envisioned. For example, if a first wooden or concrete structural or non-structural component is desired to be fixedly secured to a second wooden, concrete, or steel substrate, then the fastener 300 can be inserted into and passed through the first structural or non-structural component as a result of being driven into the first structural or non-structural component to a predetermined depth. As was appreciated in connection with the first embodiment fastener 100, as illustrated within FIGS. 3,4, and 7, the tip portion 306 will project downwardly out from the first structural or non-structural component and can therefore be anchored within the second wooden, concrete, or steel substrate. In such a case, the internally threaded bore of the second embodiment fastener 300 can be eliminated in view of the fact that the second embodiment fastener 300 is being used directly to fixedly secure the first structural or non-structural component to a second substrate as opposed to affixing a structural or non-structural component to the substrate in an indirect manner, that is, through means of the second embodiment fastener 300.

Continuing still further, while the first and second embodiment fasteners 100,300 have been previously described as being fabricated as one-piece fasteners comprising, for example, the head portions 102,302, the threaded shank portions 104,304, the tip portions 106,306, and the enlarged circular flanged portions 108,308, it is contemplated that the fasteners 100,300 can effectively be manufactured or fabricated as two piece assemblies comprising the self-drilling, self-tapping fastener per se which would include, for example, the head portion 102, the threaded shank portion 104, and the tip portion 106, and the separately fabricated enlarged circular flanged portion 108 with its cutting teeth 112 formed thereon. The manufacture or fabrication of the fastener 100 as a two-piece assembly might, in some instances, facilitate or expedite its manufacture in a relatively simplified manner. The enlarged circular flanged portion 108 would then be fixedly mounted upon the undersurface section of the head portion 102 by any one of a multiple of fixation structures or techniques. More particularly, for example, the enlarged circular flanged portion 108 can be fixedly mounted upon the underside section of the head portion 102 by a suitable crimping or swaging process, a soldering or welding process, pinning or screwing the enlarged flanged portion 108 to an undersurface section of the head portion 102, or by gluing or bonding the enlarged flanged portion 108 to an undersurface section of the head portion 102. Still yet further, the enlarged flanged portion 108 need not be fixedly or integrally secured to an undersurface section of the head portion 102, but may alternatively be effectively prevented from rotating with respect to the head portion 102 of the fastener 100 as well as with respect to the remaining structural components of the fastener 100. In this manner, the rotary torque imparted to the fastener 100 will in fact be likewise imparted to the enlarged flanged portion 108 with its cutting teeth 112 formed thereon.

More particularly, such a structural interrelationship defined between the head portion 102 of the fastener 100 and the separately fabricated enlarged flanged portion 108 of the fastener 100 is schematically illustrated within FIG. 10. In accordance with this structurally modified enlarged flanged portion or member 108′, the enlarged flanged portion or member 108′ is provided with a plurality of female through apertures 118′. The apertures 118′ can be arranged in a substantially circumferentially or annularly extending array and may have any one of several differently configured shapes, such as, for example, circular apertures, rectangular apertures, and the like. A central aperture 120′ is also of course provided so as to permit the enlarged flanged portion or member 108′ to be mounted upon the threaded shank portion 104 of the fastener 100. In a corresponding manner, undersurface sections of the head portion 102 may be provided with downwardly extending male lugs, protrusions, bosses, or the like, not shown. Accordingly, after the enlarged flanged portion or member 108′ has been mounted upon the threaded shank portion 104 of the fastener 100, it is to effectively be pushed upwardly upon the threaded shank portion 104 of the fastener 100 as far as it could be moved until the lugs, protrusions, bosses, or the like of the head portion 102 engage the enlarged flanged portion or member 108′. The central aperture 120′ of the enlarged flanged portion or member 108′ is closely toleranced to the external diameter of the threads of the threaded shank portion 104 such that the enlarged flanged portion or member 108′ will not readily become separated from the threaded shank portion 104 of the fastener. Subsequently, as the fastener 100 is beginning to be inserted into, for example, the insulated metal panel (IMP) 200, the enlarged flanged portion or member 108′ will engage the upper steel sheet 202 of the insulated metal panel (IMP) 200, the enlarged flanged portion or member 108′ will, in turn, be forced into engagement with the undersurface section of the head portion 102, and as the head portion 102 of the fastener 100 beings to rotate, the downwardly projecting lugs, protrusions, bosses, or the like, will effectively migrate, become aligned with the apertures 120′ of the enlarged circular flanged portion 108′, and fall into the apertures 120′ of the enlarged flanged portion or member 108′ whereby the enlarged flanged portion or member 108′ will now be rotationally fixed with respect to the head portion 102 of the fastener 100 such that the previously described cutting, drilling, and tapping operations can proceed as if the enlarged flanged portion or member 108′ was in fact originally fabricated as a one-piece . fastener along with the fastener per se 100.

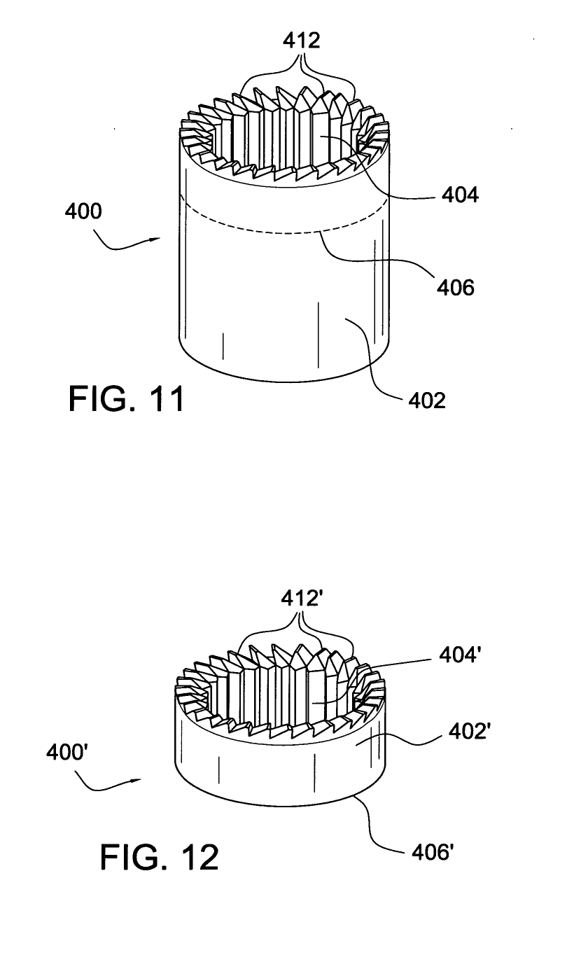

With reference now being made to FIGS. 11 and 12, there are additionally disclosed wrench sockets, or alternatively, such structures could be screw gun sockets, which have also been constructed in accordance with the teachings and principles consistent with the present invention, and which, together with a screw-threaded fastener, can effectively accomplish the various drilling, cutting and boring operations which were capable of being achieved by means of the self-counter-boring, screw-threaded fastener 100 as disclosed within, for example, FIGS. 1 and 2. A first embodiment of such a wrench or screw-gun socket is illustrated within FIG. 11 and is generally indicated by the reference character 400. The wrench or screw-gun socket 400 is substantially a conventional wrench or screw-gun socket for rotatably driving headed fasteners or similar structures, however, the wrench or screw gun socket 400 of the present invention has been modified for the particular purposes and objectives consistent with the present invention. More particularly, it is seen that the wrench or screw gun socket 400 comprises a substantially tubular wrench or screw gun socket body 402 for fitting over the head portion of a headed fastener, and that the internal peripheral wall surface of the tubular wrench or screw gun socket body 402 is provided with a plurality of axially oriented, radially inwardly extending teeth 404 which are adapted to drivingly engage the head portion of a headed fastener in a conventional manner such that rotary torque imparted to the wrench or screw gun socket by means of a socket wrench or screw gun can, in turn, be imparted to the headed fastener.

In accordance with specific modifications made with respect to a conventional wrench or screw gun socket, however, the wrench or screw gun socket 400 consistent with the present invention is also seen to comprise a plurality of axially extending cutting teeth 412 which are arranged in a circumferential array around the annular peripheral edge portion of the open end of the wrench or screw gun socket body 402 into which the head portion of the headed fastener is to be inserted. The cutting teeth 412 are essentially the same as the cutting teeth 102 disposed upon the enlarged circular flanged portion 108 of the fastener 100 as illustrated within FIGS. 1 and 2, and therefore, when the head portion of a screw-threaded headed fastener is inserted or disposed within the wrench or screw gun socket 400, the screw-threaded headed fastener, together with the wrench or screw gun socket 400, will comprise structure generally similar to the fastener 100 as illustrated within FIGS. 1 and 2. A magnet 406 is preferably disposed internally within the tubular wrench or screw gun socket body 402 so as to not only retain the headed fastener therewithin, but the head portion and the shank portion of the headed fastener will be disposed or seated at an axial position, relative to the cutting teeth 412 of the wrench or screw gun socket, in a manner similar to the disposition of the head portion 102 and the shank portion 104 of the fastener 100 with respect to the cutting teeth 112 of the enlarged circular flanged portion 108.

In this manner, it can readily be appreciated that when the wrench socket 400 and the headed fastener disposed therein are, in a similar manner to the fastener 100, utilized to bore through an insulated metal panel (IMP) 200, as illustrated within FIG. 3, the cutting teeth 412 of the wrench or screw gun socket 400 will cut through and sever a washer, similar to the washer 114 illustrated within FIG. 5 whereby the washer 114 will be seated within the wrench or screw gun socket 400 in a manner similar to the seating of the washer 114 within the enlarged circular flanged portion 108 of the fastener 100. The boring, drilling, and threading operations are also performed in a manner similar to that previously described in connection with the fastener 100, and subsequent to the headed fastener, disposed within the wrench or screw gun socket 400, being fully inserted as desired within the particular support member or substrate similar to the support member, stud, beam, joist, or the like 210, the wrench or screw gun socket 400 can then be removed thereby leaving the headed fastener within the support member, stud, beam, joist, or the like 210.

With reference now being made to FIG. 12, a modified wrench or screw gun socket, relative to the wrench or screw gun socket 400, is disclosed and is generally indicated by the reference character 400′. The only significant difference between the modified wrench or screw gun socket 400′ and the wrench or screw gun socket 400 resides in the fact that the axial length of the wrench or screw gun socket body portion 402 has been effectively reduced by a predetermined amount so as to permit the headed fastener to be properly seated or disposed therein. In lieu of a separate magnet 406 being provided within the wrench or screw gun socket 400′ as was the case of the wrench pr screw gun socket 400, the bottom or end wall portion 406′ of the wrench or screw gun socket 400′, into which the torque wrench is to be fitted, may be magnetic. All other structural components of the modified wrench or screw gun socket 400′ are substantially the same as, and operate in a substantially similar manner as, those of the wrench or screw gun socket 400. It is to be noted that while a plurality of cutting teeth 112 and 412 have been illustrated and disclosed in use with the enlarged circular flanged portion 108 or the wrench or screw gun socket body portion 402, the cutting and boring operations can also be readily achieved by means of a single cutting tooth effectively circumscribing the area of, for example, the upper steel sheet of the insulated metal panel (IMP) from which the washer will be cut, severed, and formed.

With reference now being lastly made to FIG. 14, another self-counterboring screw-threaded headed fastener is disclosed and is generally indicated by the reference character 500. It is to be noted that in lieu of the enlarged circular flanged portion character of the fastener 100, the fastener 500 is provided with a pair of radially outwardly projecting wing members 508 which are disposed upon diametrically opposite sides of the shank portion 504 of the fastener 500 at an axial position adjacent to the head portion 502. The wing members 508 have a diametrical extent which is at least as large as the diametrical extent of the head portion 502 such that when the wing members 508 bore a hole through a structural or non-structural panel, as will be described hereinafter, the head portion 502 can be readily inserted therethrough. In addition, each one of the wing members 508 is provided with an axially extending cutting tooth 512 so as to effectively serve a similar counterboring purpose as that achieved by means of the enlarged circular flanged portion 108, with its cutting teeth 112, of the fastener 102 disclosed within FIGS. 1 and 2. The diametrically opposed cutting teeth 512 will effectively circumscribe a cutting locus so as to cut and sever a washer out from, for example, an upper steel sheet of an insulated metal panel (IMP) in a manner that has been previously described with respect to the fastener 100 disclosed within FIGS. 1 and 2. The washer will then effectively be retained at an axial position beneath the wing members 508 and internally within the area circumscribed by means of the cutting teeth 512. The boring process will then proceed in substantially the same manner as has been previously described in connection with the fastener 100 disclosed within FIGS. 1 and 2.

Having described the various structural features of the various embodiments consistent with the new and improved self-counter-boring screw-threaded headed fasteners and wrench or screw gun sockets, as well as the various usage or environmental applications of the same in connection with various structural components, supports, and substrates, some additionally important or significant practical advantages of utilizing the new and improved self-counterboring screw-threaded headed fasteners and wrench sockets consistent with the present invention will now be noted. With reference reverting back to FIG. 7, it will be noted that when the headed fastener has been inserted into, for example, a structural beam, stud, joist, or other similar substrate 210, the headed fastener is effectively disposed at the bottom of the bore 208 formed by means of the enlarged circular flanged portion 108 or the wrench socket 400. Conventionally, this boring system is not usually employed in these environments, and in lieu of the fastener system of the present invention, relatively long-shank fasteners are employed whereby the head portions of such long-shank fasteners are disposed atop the upper steel sheet 202. Since the pointed tip portions of such fasteners are disposed within the underlying steel beams, studs, joists, or the like, a thermal conduit is effectively formed from the underlying structural beam, stud, joist, or the like, upwardly through the long-shank fastener, and out to the external steel sheet 202 covering, for example, an external building wall, roof, floor, or the like. This thermal conduit therefore permits leakage of heat from within the building to the external atmosphere.

With the fastening system of the present invention, however, this thermal conduit is effectively terminated at the head portion 102 of the fastener 100 because the head portion 102 of the fastener is located at the bottom of the bore 208 formed within the insulated metal panel (IMP) 200. More particularly, the head portion 102 of the fastener 100 is effectively surrounded by means of the insulated core 206, and in addition, in order to further prevent the travel of any thermal radiation upwardly within the bore 208, insulator plugs, not shown, fabricated from a suitable insulation material, such as rubber, neoprene, or the like, may be disposed within the bores 208. It is further noted that by conventionally using the aforenoted relatively long shank fasteners to extend downwardly through the insulated metal panels (IMPs), significant shear stresses are imparted to such long shank fasteners. It is to be appreciated that the insulated metal panels (IMPs) can be subjected to severe hot and cold temperatures, wind forces, and the like, which cause the same to expand and contract and otherwise move relative to the underlying support structure or substrates. Accordingly, these forces impress significant shear loading upon the long-shank fasteners. With the fasteners of the present invention, however, installed within the insulated metal panels (IMPs) as disclosed, for example, within FIG. 7, only the head portions 102 of the fasteners are disposed above the lower steel sheet 204 of the insulated metal panel (IMP) 200 whereby such shear forces do not present a significant problem.

Obviously, many variations and modifications of the present invention are possible in light of the above teachings. It is therefore to be understood that within the scope of the appended claims, the present invention may be practiced otherwise than as specifically described herein.

What is claimed as new and desired to be protected by means of Letters Patent of the United States is:

1. A self-counterboring screw-threaded fastener for insertion into a member, comprising:
a threaded shank portion defined around a longitudinal axis and having threads thereon;
a tip portion formed upon a first end of said threaded shank portion for insertion through the member;
a head portion disposed upon a second opposite end of said threaded shank portion;
structure disposed upon said threaded shank portion, projecting radially outwardly from said threaded shank portion, and interposed between said threads, disposed upon said threaded shank portion of said fastener, and said head portion of said fastener; and
at least one cutting tooth disposed upon said radially outwardly projecting structure for boring through the member whereby said screw-threaded fastener head can be inserted into the member without requiring a bore to first be pre-drilled within the member.

2. The screw-threaded fastener as set forth in claim 1, wherein:
said structure disposed upon said threaded shank portion comprises an enlarged flanged portion and said at least one cutting tooth comprises a plurality of cutting teeth.

3. The screw-threaded fastener as set forth in claim 2, wherein:
said enlarged flanged portion has a substantially circular configuration; and
said plurality of axially extending cutting teeth are disposed within a circumferential array upon an outer peripheral edge portion of said enlarged circular flanged portion.

4. The screw-threaded fastener as set forth in claim 2, wherein:
said screw-threaded fastener, comprising said threaded shank portion, said tip portion, said head portion, and said enlarged flanged portion, comprises a one-piece fastener.

5. The screw-threaded fastener as set forth in claim 2, wherein:
said screw-threaded fastener comprises a two-piece fastener assembly wherein a first piece of said two-piece fastener assembly comprises said threaded shank portion, said tip portion, and said head portion, while a second piece of said two-piece fastener assembly comprises said enlarged flanged portion.

6. The screw-threaded fastener as set forth in claim 5, wherein:
said enlarged flanged portion, comprising said second piece of said two-piece fastener assembly, is adapted to be fixedly secured to said first piece of said two-piece fastener assembly.

7. The screw-threaded fastener as set forth in claim 6, wherein:
said enlarged flanged portion, comprising said second piece of said two-piece fastener assembly, is adapted to be fixedly secured to said first piece of said two-piece fastener assembly by a fixation process selected from the group comprising soldering, welding, gluing, bonding, crimping, swaging, pinning, and screwing.

8. The screw-threaded fastener as set forth in claim 6, wherein:
said enlarged flanged portion, comprising said second piece of said two-piece fastener assembly, is adapted to be fixedly secured to said first piece of said two-piece fastener assembly as a result of male members, disposed upon an undersurface section of said head portion being matingly fitted within female apertures defined within said enlarged flanged portion.

9. The screw-threaded fastener as set forth in claim 2, further comprising:
a second set of axially extending grinding/pulverizing teeth disposed upon undersurface portions of said enlarged flanged portion for permitting said screw-threaded fastener to be inserted into a structure when the structure is fabricated from one of wood and concrete.

10. The fastener as set forth in claim 9, wherein:
an internally threaded bore is defined within said head portion of said fastener for receiving a threaded fastener such that an article may be fixedly secured to said screw-threaded fastener which is inserted into one of the wood and concrete structures.

11. The fastener as set forth in claim 1, wherein:
said structure disposed upon said threaded shank portion comprises a pair of diametrically opposed wing members wherein each one of said wing members is provided with an axially extending cutting tooth.

12. In combination, a panel member to be secured to an underlying substrate, and a self-counterboring screw-threaded fastener for securing the member to the underlying substrate, comprising:
a panel member comprising a laminated sandwich assembly including an upper metal sheet, a lower metal sheet, and an intermediate core member interposed between said upper and lower metal sheets; and
a self-counterboring screw-threaded fastener comprising a threaded shank portion defined around a longitudinal axis and having threads thereon for insertion into the underlying substrate; a tip portion disposed upon a first end of said threaded shank portion for insertion through said structural member and into the underlying substrate; a head portion disposed upon a second opposite end of said threaded shank portion; structure disposed upon said threaded shank portion, projecting radially outwardly from said threaded shank portion, and interposed between said threads, disposed upon said threaded shank portion of said fastener, and said head portion of said fastener; and at least one axially extending cutting tooth disposed upon said structure for boring through said upper metal sheet of said laminated sandwich assembly and thereby forming and severing a metal washer from said upper metal sheet wherein said metal washer is secured beneath said structure so as to permit said screw-threaded fastener to bore through said upper metal sheet and form a bore within said intermediate core member of said laminated sandwich assembly, but to effectively prevent said at least one cutting tooth from boring through said lower metal sheet of said laminated sandwich structure, whereby said screw-threaded fastener head can be inserted into said laminated sandwich assembly, without requiring a bore to first be predrilled within said laminated sandwich assembly, while said tip portion and said threads are subsequently inserted into the underlying substrate in order to fixedly secure said laminated sandwich assembly to the underlying substrate.

13. The combination as set forth in claim 12, wherein:
said laminated sandwich assembly comprises an insulated metal panel (IMP).

14. The combination as set forth in claim 13, wherein:
said lower metal sheet of said insulated metal panel (IMP) comprises a roof decking member.

15. The combination as set forth in claim 12, wherein:
said screw-threaded fastener is disposed within a bottom portion of said bore formed within said intermediate core member of said laminated sandwich assembly so as to effectively terminate a thermal radiation circuit from the underlying substrate, through said screw-threaded fastener, and to said upper metal sheet of said laminated sandwich assembly.

16. The combination as set forth in claim 12, wherein:
said screw-threaded fastener is disposed within a bottom portion of said bore formed within said intermediate core member of said laminated sandwich assembly so as to effectively minimize shear stresses imparted to said screw-threaded fastener.

17. A wrench/screw gun socket for use with a self-counterboring screw-threaded headed fastener in order to permit the self-counter-boring screw-threaded headed fastener to be inserted into a structure, comprising:
a tubular wrench/screw gun socket body having a first end for operatively cooperating with a torque wrench/screw gun, and a second opposite open end;
a plurality of axially oriented, radially inwardly extending teeth disposed upon internal peripheral wall portions of said tubular wrench/screw gun socket body for drivingly engaging the head portion of a headed fastener; and
at least one axially extending cutting tooth disposed upon said open end of said tubular wrench/screw gun socket body such that when said plurality of axially oriented, radially inwardly extending teeth operatively engage the head portion of the headed fastener so as to impart driving torque to the headed fastener, said at least one axially extending cutting tooth, disposed upon said open end of said tubular wrench/screw gun socket body can bore through the structure whereby the screw-threaded headed fastener head can be inserted into the structure without requiring a bore to first be pre-drilled within the structure.

18. The wrench/screw gun socket as set forth in claim 17, wherein:
said open end of said tubular wrench/screw gun socket body comprises an annular peripheral edge portion; and
said at least one axially extending cutting tooth comprises a plurality of axially extending cutting teeth which are disposed in a circumferential circular array upon said annular peripheral edge portion of said open end of said tubular wrench/screw gun socket body.

19. The wrench/screw gun socket as set forth in claim 17, wherein:
a magnet is disposed at a predetermined axial position internally within said tubular wrench/screw gun socket body so as to properly hold the headed fastener at a predetermined axial position within said tubular wrench/screw gun socket body and with respect to said at least one axially extending cutting tooth of said tubular wrench/screw gun socket body.

20. The wrench/screw gun socket as set forth in claim 17, wherein:
said tubular wrench socket body has a predetermined axial length so as to properly seat the headed fastener at a predetermined axial position within said tubular wrench/screw gun socket body and with respect to said at least one axially extending cutting tooth of said tubular wrench/screw gun socket body.

21. The wrench/screw-gun socket as set forth in claim 20, wherein:
said end wall of said tubular wrench/screw gun socket body, which is adapted to be operatively connected to a torque wrench/screw gun, is fabricated from a magnetic material so as to retain the headed fastener within said tubular wrench socket body.

22. In combination, a panel member to be secured to an underlying substrate, a wrench/screw gun socket, and a screw-threaded fastener for securing the member to the underlying substrate, comprising:
a panel member comprising a laminated sandwich assembly including an upper metal sheet, a lower metal sheet, and an intermediate core member interposed between said upper and lower metal sheets;
a screw-threaded fastener comprising a threaded shank portion defined around a longitudinal axis and having threads thereon for insertion into the underlying substrate; a tip portion disposed upon a first end of said threaded shank portion for insertion through said panel member and into the underlying substrate; and a head portion disposed upon a second opposite end of said threaded shank portion; and
a wrench/screw gun socket operatively engaged with said head portion of said fastener and having at least one axially extending cutting tooth disposed thereon for boring through said upper metal sheet of said laminated sandwich assembly and thereby forming and severing a metal washer from said upper metal sheet wherein said metal washer is secured within said wrench/screw gun socket so as to permit said wrench/screw gun socket and said screw-threaded fastener to bore through said upper metal sheet and form a bore within said intermediate core member of said laminated sandwich assembly, but to effectively prevent said at least one cutting tooth of said wrench/screw gun socket to bore through said lower metal sheet of said laminated sandwich structure, whereby said screw-threaded fastener head can be inserted into said laminated sandwich assembly, without requiring a bore to first be pre-drilled within said laminated sandwich assembly, while said tip portion and said threads are subsequently inserted into the underlying substrate in order to fixedly secure said laminated sandwich assembly to the underlying substrate.

23. In combination, a panel member to be secured to an underlying substrate, and a screw-threaded fastener for securing the structural member to the underlying substrate, comprising:
a panel member comprising a laminated sandwich assembly including an upper metal sheet, a lower metal sheet, and an intermediate core member interposed between said upper and lower metal sheets; and
a screw-threaded fastener comprising a threaded shank portion defined around a longitudinal axis and having threads thereon for insertion into the underlying substrate; a tip portion disposed upon a first end of said threaded shank portion for insertion through said structural member and into the underlying substrate; a head portion disposed upon a second opposite end of said threaded shank portion; and a pair of diametrically opposed wing members wherein each one of said wing members is provided with an axially extending cutting tooth for boring through said upper metal sheet of said laminated sandwich assembly and thereby forming and severing a metal washer from said upper metal sheet wherein said metal washer is secured, beneath said wing members and radially inwardly of said cutting teeth so as to permit said screw-threaded fastener to bore through said upper metal sheet and form a bore within said intermediate core member of said laminated sandwich assembly, but to effectively prevent said cutting teeth of said wing members to bore through said lower metal sheet of said laminated sandwich structure, whereby said screw-threaded fastener head can be inserted into said laminated sandwich assembly, without requiring a bore to first be pre-drilled within said laminated sandwich assembly, while said tip portion and said threads are subsequently inserted into the underlying substrate in order to fixedly secure said laminated sandwich assembly to the underlying substrate.
